(19) United States
(12) Patent Application Publication
(10) Pub. No.: US 2022/0174144 A1
(43) Pub. Date: Jun. 2, 2022

(54) TECHNOLOGIES FOR COVERT COMMUNICATION WITH EMERGENCY DISPATCH

(71) Applicant: Nickolas Turner, Indianapolis, IN (US)

(72) Inventor: Nickolas Turner, Indianapolis, IN (US)

(21) Appl. No.: 17/539,425

(22) Filed: Dec. 1, 2021

Related U.S. Application Data
(60) Provisional application No. 63/119,874, filed on Dec. 1, 2020.

(51) Int. Cl. H04M 1/72424; H04M 1/72436; H04M 1/72409; H04W 76/50

(52) U.S. Cl. CPC H04M 1/72424; H04M 1/72436; H04M 2250/52; H04W 76/50; H04M 1/72409

(57) ABSTRACT

A method of covert communication between a mobile device and emergency dispatch according to one embodiment includes receiving, by the mobile device, a user's selection of a covert communication option on a user interface of the mobile device, establishing, by the mobile device, a communication connection with an emergency dispatch system in response to receiving the user's selection of the covert communication option, and launching, by the mobile device, a text-based conversation with the emergency dispatch system in response to establishing the communication connection and without revealing an existence of the communication connection to other persons in a vicinity of the mobile device.

### CROSS-REFERENCE TO RELATED APPLICATIONS

This application claims priority to and the benefit of U.S. Provisional Application No. 63/119,874, titled “Technologies for Covert Communication with Emergency Dispatch,” filed on Dec. 1, 2020, the contents of which are incorporated herein by reference in their entirety.

### BACKGROUND

The emergency 911 system has been relied upon by Americans in emergent situations for decades. In recent years, the emergency 911 system has been expanded to support communication with cellular phones, communication with Voice over Internet Protocol (VoIP) phones, and even text-to-911 communication technologies. Accordingly, individuals in emergent circumstances now have a wide array of options to seek help. There remains a need, however, to assist those individuals such as domestic abuse victims who need urgent assistance but are unable to openly seek help without further exacerbating already hostile circumstances.

### SUMMARY

One embodiment is directed to a unique system, components, and methods for covert communication with emergency dispatch. Other embodiments are directed to apparatuses, systems, devices, hardware, methods, and combinations thereof for covert communication with emergency dispatch.

According to an embodiment, a method of covert communication between a mobile device and emergency dispatch may include receiving, by the mobile device, a user's selection of a covert communication option on a user interface of the mobile device, establishing, by the mobile device, a communication connection with an emergency dispatch system in response to receiving the user's selection of the covert communication option, and launching, by the mobile device, a text-based conversation with the emergency dispatch system in response to establishing the communication connection and without revealing an existence of the communication connection to other persons in a vicinity of the mobile device.

In some embodiments, the method may further include providing a user interface option on the user interface to toggle enablement of a microphone of the mobile device without revealing a change in status of the microphone activity to other persons in the vicinity of the mobile device.

In some embodiments, the method may further include providing a user interface option on the user interface to toggle enablement of a camera of the mobile device without revealing a change in status of the camera activity to other persons in the vicinity of the mobile device.

In some embodiments, the method may further include providing a first user interface option on the user interface to toggle enablement of a microphone of the mobile device without revealing a change in status of the microphone activity to other persons in the vicinity of the mobile device, and providing a second user interface option on the user interface to toggle enablement of a camera of the mobile device without revealing a change in status of the camera activity to other persons in the vicinity of the mobile device.

In some embodiments, the communication connection between the mobile device and the emergency dispatch system may be unable to be disconnected by the mobile device once established.

In some embodiments, the method may further include closing the user interface in response to a disconnection of the communication connection between the mobile device and the emergency dispatch system by the emergency dispatch system.

In some embodiments, establishing the communication connection with the emergency dispatch system may include initiating, by the mobile device, the communication connection with the emergency dispatch system, providing, by the mobile device, a time delay to allow the user to cancel the communication connection for a period of time before establishing the communication connection, and establishing the communication connection in response to the user not canceling the communication connection.

In some embodiments, the time delay may be three seconds.

In some embodiments, establishing the communication connection may include establishing the communication connection via an Internet Protocol (IP) connection.

In some embodiments, the method may further include automatically notifying, by the mobile device, a predefined third party in response to establishing the communication connection with the emergency dispatch system.

According to another embodiment, a mobile device for covert communication with emergency dispatch may include a processor and a memory comprising a plurality of instructions stored thereon that, in response to execution by the processor, causes the mobile device to receive a user's selection of a covert communication option on a user interface of the mobile device, establish a communication connection with an emergency dispatch system in response to receipt of the user's selection of the covert communication option, and launch a text-based conversation with the emergency dispatch system in response to establishing the communication connection and without revealing an existence of the communication connection to other persons in a vicinity of the mobile device.

In some embodiments, the plurality of instructions may further cause the mobile device to provide a user interface option on the user interface to toggle enablement of a microphone of the mobile device without revealing a change in status of the microphone activity to other persons in the vicinity of the mobile device.

In some embodiments, the plurality of instructions may further cause the mobile device to provide a user interface option on the user interface to toggle enablement of a camera of the mobile device without revealing a change in status of the camera activity to other persons in the vicinity of the mobile device.

In some embodiments, the plurality of instructions may further cause the mobile device to provide a first user interface option on the user interface to toggle enablement of a microphone of the mobile device without revealing a change in status of the microphone activity to other persons in the vicinity of the mobile device, and provide a second user interface option on the user interface to toggle enablement of a camera of the mobile device without revealing a change in status of the camera activity to other persons in the vicinity of the mobile device.

In some embodiments, the communication connection between the mobile device and the emergency dispatch system may be unable to be disconnected by the mobile device once established.

In some embodiments, the plurality of instructions may further cause the mobile device to close the user interface in response to a disconnection of the communication connection between the mobile device and the emergency dispatch system by the emergency dispatch system.

In some embodiments, to establish the communication connection with the emergency dispatch system may include to initiate the communication connection with the emergency dispatch system, provide a time delay to allow the user to cancel the communication connection for a period of time before establishing the communication connection, and establish the communication connection in response to the user not canceling the communication connection.

In some embodiments, the time delay may be three seconds.

In some embodiments, to establish the communication connection may include to establish the communication connection via an Internet Protocol (IP) connection.

In some embodiments, the plurality of instructions may further cause the mobile device to automatically notify a predefined third party in response to establishing the communication connection with the emergency dispatch system.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a simplified block diagram of at least one embodiment of a system for covert communication between a mobile device and emergency dispatch;

FIG. 2 is a simplified block diagram of at least one embodiment of a computing system;

FIGS. 3-4 are a simplified flow diagram of at least one embodiment of a method for covert communication with emergency dispatch; and

FIGS. 5-10 are simplified diagrams of at least one embodiment of a graphical user interface of the mobile device of FIG. 1 that enables covert communication with emergency dispatch.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

The terms longitudinal, lateral, and transverse may be used to denote motion or spacing along three mutually perpendicular axes, wherein each of the axes defines two opposite directions. The directions defined by each axis may also be referred to as positive and negative directions. Additionally, the descriptions that follow may refer to the directions defined by the axes with specific reference to the orientations illustrated in the figures. For example, the directions may be referred to as distal/proximal, left/right, and/or up/down. It should be appreciated that such terms may be used simply for ease and convenience of description and, therefore, used without limiting the orientation of the system with respect to the environment unless stated expressly to the contrary. For example, descriptions that reference a longitudinal direction may be equally applicable to a vertical direction, a horizontal direction, or an off-axis orientation with respect to the environment. Furthermore, motion or spacing along a direction defined by one of the axes need not preclude motion or spacing along a direction defined by another of the axes. For example, elements described as being “laterally offset” from one another may also be offset in the longitudinal and/or transverse directions, or may be aligned in the longitudinal and/or transverse directions. The terms are therefore not to be construed as further limiting the scope of the subject matter described herein.

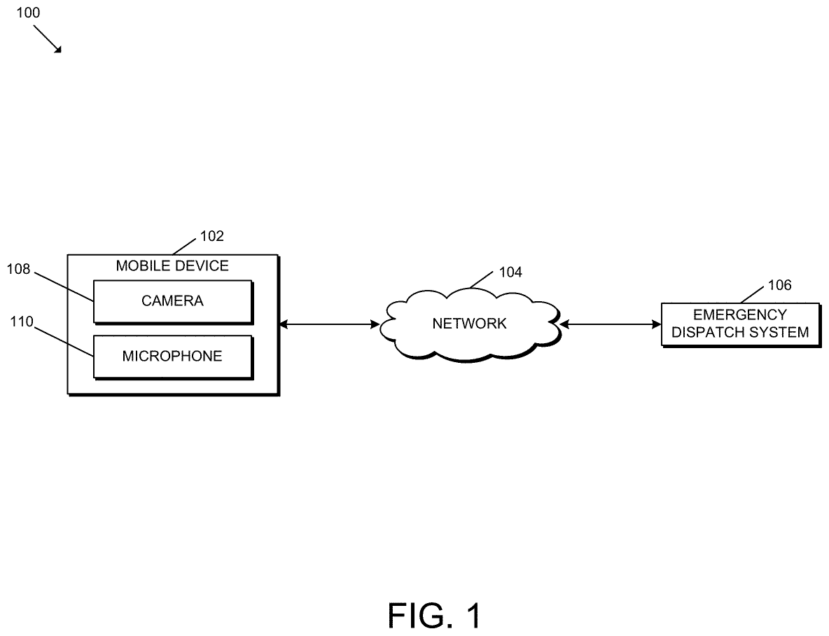

Referring now to FIG. 1, a system 100 for covert communication with emergency dispatch includes a mobile device 102, a network 104, and an emergency dispatch system 106. Further, the illustrative mobile device 102 includes at least one camera 108 and at least one microphone 110. In some embodiments, it should be appreciated that the mobile device 102 may also include a display, speaker, and/or other components commonly included in mobile devices. The technologies described herein allow a user of the mobile device 102 to initiate a covert communication option (e.g., via a “panic button” of a graphical user interface displayed on the mobile device 102) that establishes a communication connection with the emergency dispatch system 106 (e.g., a 911 operator) and launches a text-based conversation with the emergency dispatch system 106 without revealing the existence of the communication connection to other persons in a vicinity of the mobile device 102. Further, as described below, the user interface of the mobile device 102 allows the user to enable/disable the camera 108 and/or the microphone 110 of the mobile device 102. For example, in some embodiments, after connected, the mobile device 102 may serve at least in part (e.g., audio/video) as a one-way communication mechanism to the emergency dispatch system 106 without alerted others near the mobile device 102 that data is being transmitting.

It should be appreciated that the mobile device 102 and/or the emergency dispatch system 106 may be embodied as any type of device or collection of devices suitable for performing the functions described herein. More specifically, in the illustrative embodiment, the mobile device 102 may be embodied as any type of device capable of capturing images/audio and displaying information for a user of the mobile device 102.

The mobile device 102 may include an application that enables the mobile device 102 to capture images/audio, display a graphical user interface, and establish communication connections (e.g., via an IP protocol). It should be appreciated that the application may be embodied as any suitable application for performing the functions described herein. For example, in some embodiments, the application may be embodied as a mobile application (e.g., smartphone application). In some embodiments, it should be appreciated that the application may serve as a client-side user interface for a web-based application or service of a server.

The camera 108 may be embodied as any type of device capable of capturing one or more images discretely or in a stream. For example, the camera 108 may include one or more two-dimensional (2D) cameras, three-dimensional (3D) cameras, and/or video cameras. Although the camera 108 is described herein generally as including image sensors that captured the visual light spectrum, it should be appreciated that the camera 108 may be configured to capture waves/signals in the non-visual light spectrum in other embodiments. Although the camera 108 is primarily described herein in the singular, it should be appreciated that the mobile device 102 may include multiple cameras 108 in other embodiments and the techniques described herein apply equally well to such an embodiment. The microphone 110 may be embodied as any type of device capable of capturing audio. Although the microphone 110 is primarily described herein in the singular, it should be appreciated that the mobile device 102 may include multiple microphones 110 in other embodiments and the techniques described herein apply equally well to such an embodiment. It should be further appreciated that the mobile device 102 may include a display capable of displaying a graphical user interface for a user of the mobile device 102. For example, in some embodiments, the mobile device 102 may include a touchscreen display. Additionally, in some embodiments, the mobile device 102 may include one or more speakers for rendering audio to a user of the mobile device 102 (e.g., voice audio from the emergency dispatcher).

The network 104 may be embodied as any type of communication network capable of facilitating communication between the various devices of the system 100. As such, the network 104 may include one or more networks, routers, switches, computers, and/or other intervening devices. For example, the network 104 may be embodied as or otherwise include one or more cellular networks, telephone networks, local or wide area networks, publicly available global networks (e.g., the Internet), ad hoc networks, short-range communication links, or a combination thereof.

The emergency dispatch system 106 may be embodied as any type of device(s) capable of performing the functions described herein. In the illustrative embodiment, the emergency dispatch system 106 may include one or more devices operated by an emergency dispatcher (e.g., in a 911 call center) to communicate with persons who contact the emergency dispatcher via a 911 call, text message, or otherwise. It should be appreciated that the emergency dispatch system 106 may include one or more servers and/or user interface devices.

It should be appreciated that, in some embodiments, one or more servers of the server emergency dispatch system 106 may be embodied as a cloud-based device or collection of devices within a cloud computing environment. Further, in cloud-based embodiments, such servers may be embodied as a server-ambiguous computing solution, for example, that executes a plurality of instructions on-demand, contains logic to execute instructions only when prompted by a particular activity/trigger, and does not consume computing resources when not in use. That is, the server(s) may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the server(s) described herein. For example, when an event occurs (e.g., data is transferred to the server(s) for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of access control data is made (e.g., via an appropriate user interface to the server(s)), the appropriate virtual function(s) may be executed to perform the actions before eliminating the instance of the virtual function(s).

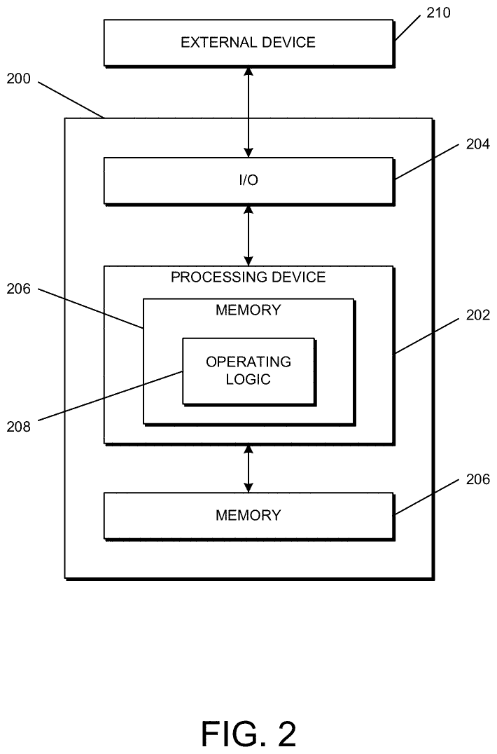

It should be appreciated that each of the mobile device 102 and/or the emergency dispatch system 106 may be embodied as a computing device/system similar to the computing system 200 described below in reference to FIG. 2. For example, in the illustrative embodiment, one or more of the mobile device 102 and/or the emergency dispatch system 106 may include a processing device 202 and a memory 206 having stored thereon operating logic 208 for execution by the processing device 202 for operation of the corresponding device.

Referring now to FIG. 2, a simplified block diagram of at least one embodiment of a computing system 200 is shown. The illustrative computing system 200 depicts at least one embodiment of the mobile device 102 and/or the emergency dispatch system 106 illustrated in FIG. 1. Depending on the particular embodiment, the computing system 200 may be embodied as a mobile computing device, server, desktop computer, laptop computer, tablet computer, notebook, netbook, Ultrabook™, cellular phone, smartphone, wearable computing device, personal digital assistant, Internet of Things (IoT) device, control panel, router, gateway, and/or any other computing, processing, and/or communication device capable of performing the functions described herein.

The computing system 200 includes a processing device 202 that executes algorithms and/or processes data in accordance with operating logic 208, an input/output device 204 that enables communication between the computing system 200 and one or more external devices 210, and memory 206 which stores, for example, data received from the external device 210 via the input/output device 204.

The input/output device 204 allows the computing system 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry may be configured to use any one or more communication technologies (e.g., wireless or wired communications) and associated protocols (e.g., Ethernet, Bluetooth®, Wi-Fi®, WiMAX, etc.) to effect such communication depending on the particular computing system 200. The input/output device 204 may include hardware, software, and/or firmware suitable for performing the techniques described herein.

The external device 210 may be any type of device that allows data to be inputted or outputted from the computing system 200. For example, in various embodiments, the external device 210 may be embodied as the mobile device 102 and/or the emergency dispatch system 106. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing system 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is of a programmable variety that executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable variety, such as a disk, tape, memory stick, cartridge, and/or other suitable portable memory. In operation, the memory 206 may store various data and software used during operation of the computing system 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing system 200 may form a portion of a system-on-a-chip (SoC) and be incorporated on a single integrated circuit chip.

In some embodiments, various components of the computing system 200 (e.g., the processing device 202 and the memory 206) may be communicatively coupled via an input/output subsystem, which may be embodied as circuitry and/or components to facilitate input/output operations with the processing device 202, the memory 206, and other components of the computing system 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing system 200 may include other or additional components, such as those commonly found in a typical computing device (e.g., various input/output devices and/or other components), in other embodiments. It should be further appreciated that one or more of the components of the computing system 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing system 200 may include multiple processing devices 202, I/O devices 204, and/or memories 206 in other embodiments. Further, in some embodiments, more than one external device 210 may be in communication with the computing system 200.

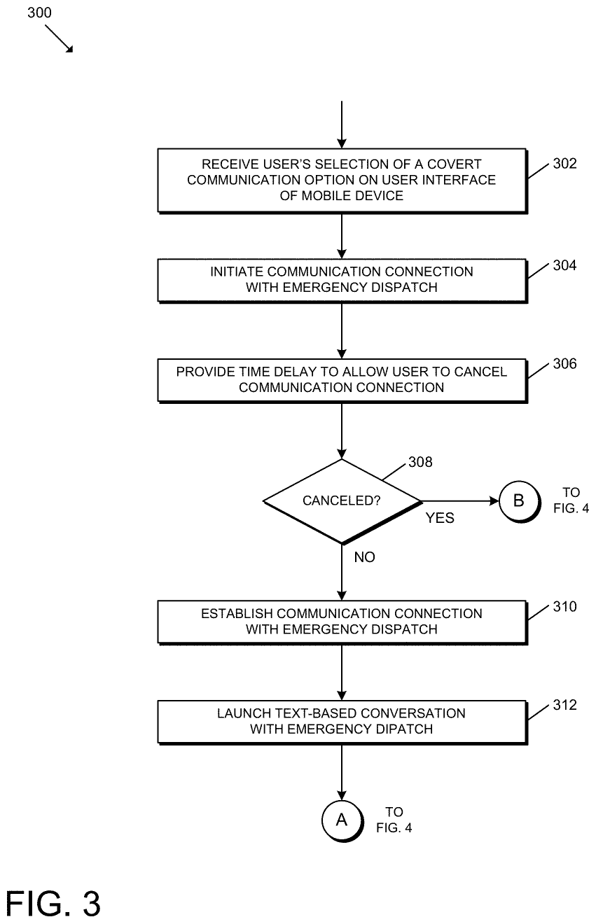

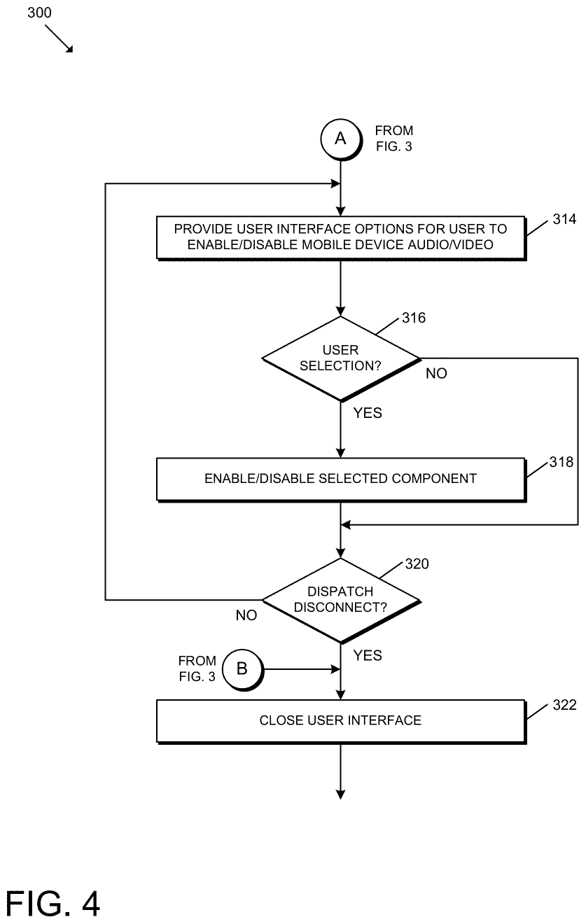

Referring now to FIGS. 3-4, in use, the system 100 (e.g., in conjunction with a user) may execute a method 300 for covert communication with emergency dispatch. It should be appreciated that the particular blocks of the method 300 are illustrated by way of example, and such blocks may be combined or divided, added or removed, and/or reordered in whole or in part depending on the particular embodiment, unless stated to the contrary.

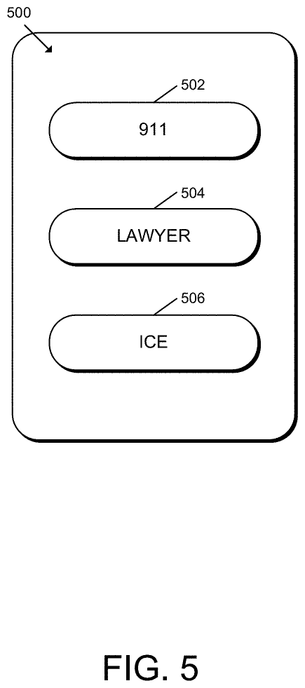

The illustrative method 300 begins with block 302 of FIG. 3 in which the mobile device 102 receives a user's selection of a covert communication option on a user interface of the mobile device 102 (e.g., a graphical user interface displayed to the user). For example, in some embodiments, the graphical user interface may include a “panic button,” such as the user interface option 502 of the graphical user interface 500 of FIG. 5. It should be appreciated that the covert communication option may be a part of a standalone application, or the option may be integrated into another application and displayed as a portion of that app (e.g., in the bottom corner of a particular graphical user interface of another application).

In block 304, the mobile device 102 initiates a communication connection with the emergency dispatch system 106 in response to the user selecting the covert communication option (e.g., the option 502 of FIG. 5). It should be appreciated that the mobile device 102 may use any suitable communication technologies and/or protocols in order to communicate with the emergency dispatch system 106. For example, in some embodiments, communication may involve government-defined protocols and/or technologies.

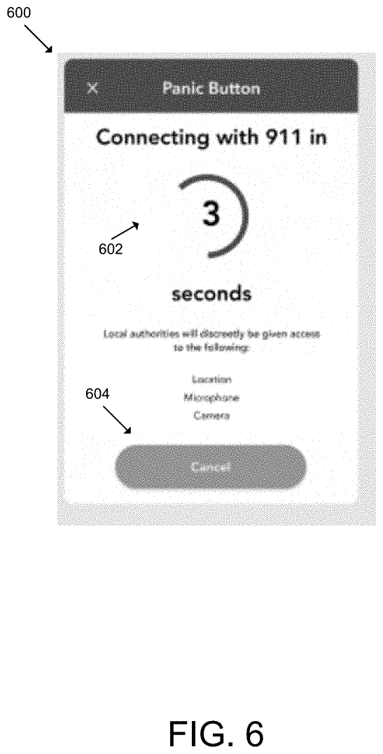

In block 306, the mobile device 102 provides a time delay to allow the user to cancel the communication connection initiated with the emergency dispatch system 106. It should be appreciated that the time delay allows, for example, the user to rectify an inadvertent activation of the covert communication option before the time delay lapses. Further, the length of the time delay may vary depending on the particular embodiment (e.g., 3 seconds, 5 seconds, 10 seconds, etc.). In some embodiments, the length of the time delay may be configured or modified from a default length by the user (e.g., via the application). By way of example, in some embodiments, the mobile device 102 may display a graphical user interface similar to the graphical user interface 600 of FIG. 6 in response to the user's selection of the covert communication option (e.g., the option 502 of FIG. 5). As shown in FIG. 6, the graphical user interface 600 may display a timer element 602 that counts down to zero until the time delay has expired, and a cancel option 604 that allows the user to cancel the communication connection with the emergency dispatch system 106.

If the mobile device 102 determines, in block 308, that the user cancels the communication connection, the method 300 advances to block 322 of FIG. 4 in which the mobile device 102 closes the user interface. However, if the mobile device 102 determines that the time delay has expired without the user canceling the communication connection, the method 300 advances to block 310 in which the mobile device 102 continues to establish the communication connection with the emergency dispatch system 106 (e.g., via an IP protocol). It should be appreciated that, upon connecting with the emergency dispatch system 106, the emergency dispatch system 106 will have access to various data of the mobile device 102 depending on the particular default settings of the mobile device 102. For example, the mobile device 102 may transmit geographical location data, audio data, video data, and/or other data to the emergency dispatch system 106 depending on the default settings. In other embodiments, it should be appreciated that the mobile device 102 may not attempt to initiate the communication connection with the emergency dispatch system 106 until the time delay has lapsed.

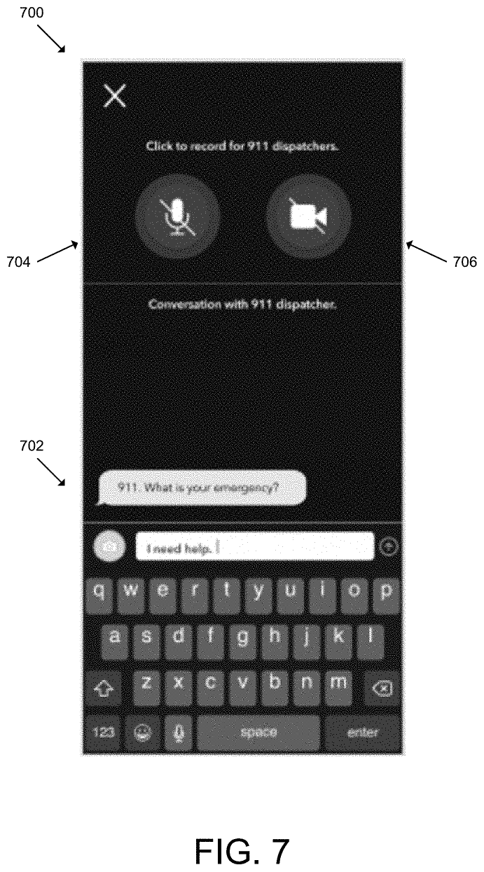

Further, in response to establishing the communication connection, in block 312, the mobile device 102 launches a text-based conversation with the emergency dispatch system 106 and may do so without revealing the existence of a communication to other persons in a vicinity of the mobile device 102 (e.g., persons other than the user of the mobile device 102). For example, in some embodiments, the mobile device 102 may display a graphical user interface similar to the graphical user interface 700 of FIGS. 7-10. As shown in FIGS. 7-10, the graphical user interface 700 includes text-based conversation elements 702 that allow the user of the mobile device 102 to communicate with the emergency dispatcher. It should be appreciated that, in some embodiments, the mobile device 102 transmits the messages via an IP protocol; however, it should be appreciated that the emergency dispatch system 106 may receive the messages, for example, via an SMS text message. In other words, in some embodiments, the system 100 may be integrated with the text-to-911 system of the emergency dispatch system 106.

In block 314 of FIG. 4, the mobile device 102 provides user interface options that allow the user to enable/disable audio and/or video of the mobile device 102. For example, in some embodiments, the graphical user interface 700 includes an audio option 704 that allows the user to toggle (i.e., enable/disable) the microphone 110 of the mobile device 102 and a video option 706 that allows the user to toggle (i.e., enable/disable) the camera 108 of the mobile device 102. As described above, it should be appreciated that the mobile device 102 allows the audio and/or video to be toggled without revealing any change in the status of the activity of the microphone 110 and/or camera 108 to persons in the vicinity of the mobile device 102. For example, in such embodiments, the microphone 110 and/or camera 108 may be enabled without activating external indicia (e.g., a “camera active” LED) on the mobile device 102.

In block 316, the mobile device 102 determines whether the user has made a selection of one of the options. If not, the method 300 advances to block 320. However, if the user has made a selection of one of the options, the method 300 advances to block 318 in which the mobile device 102 toggles the status (e.g., enables/disables) of the selected component (e.g., the microphone 110 or the camera 108). It should be appreciated that, in the illustrative embodiment, the user is unable to deactivate/disconnect the communication connection between the mobile device 102 and the emergency dispatch system 106 once the connection has been established (e.g., to prevent a domestic abuser or other nefarious actor from interfering in the communication). Accordingly, the communication connection remains established until the emergency dispatcher has disconnected. Further, in some embodiments, once the communication connection has been established, the mobile device 102 may also be prevented from powering down until the emergency dispatcher has disconnected (or the battery life has expired). In other embodiments, however, the user may be permitted to deactivate/disconnect the communication connection between the mobile device 102 and the emergency dispatch system 106 and/or power down the mobile device 102.

In block 320, the mobile device 102 determines whether the emergency dispatch system 106 has disconnected with the mobile device 102. If not, the method 300 returns to block 314 in which the mobile device 102 continues to provider the user with options to toggle the microphone 110 and camera 108 status and to communicate with the emergency dispatch system 106 via the text-based conversation elements 702. However, the mobile device 102 determines that the emergency dispatch system 106 has disconnected with the mobile device 102, the method 300 advances to block 322 in which the mobile device 102 closes the interface.

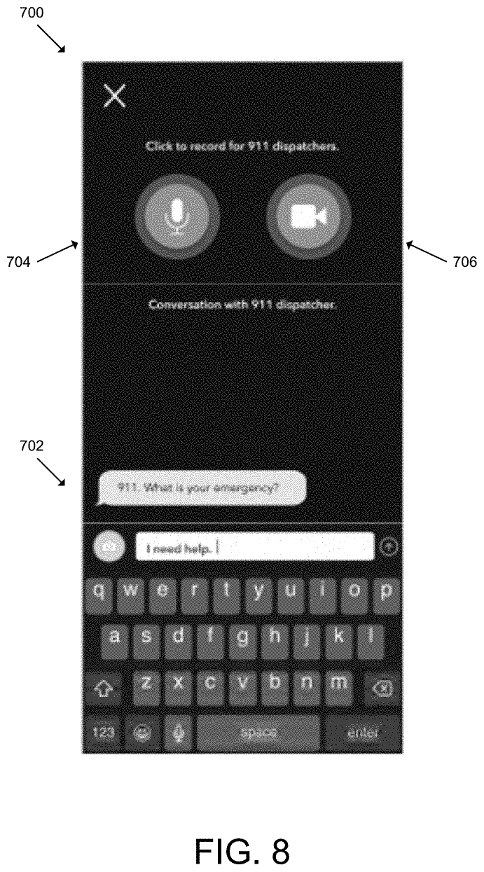

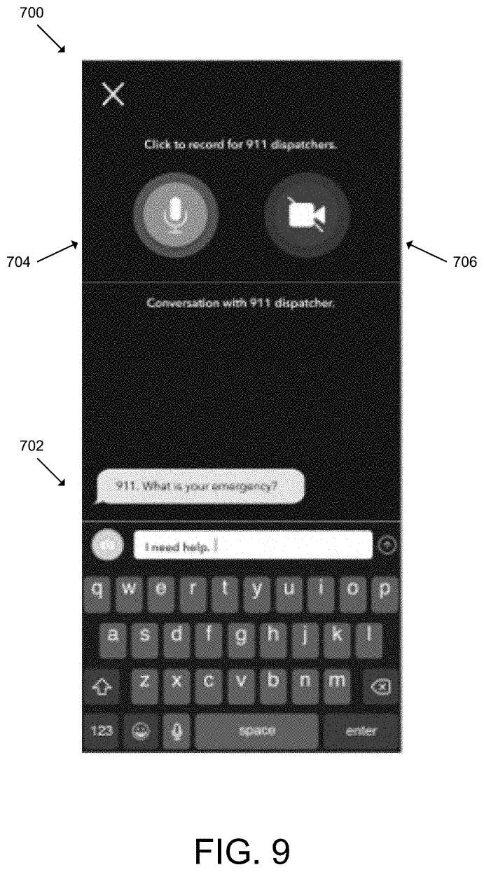

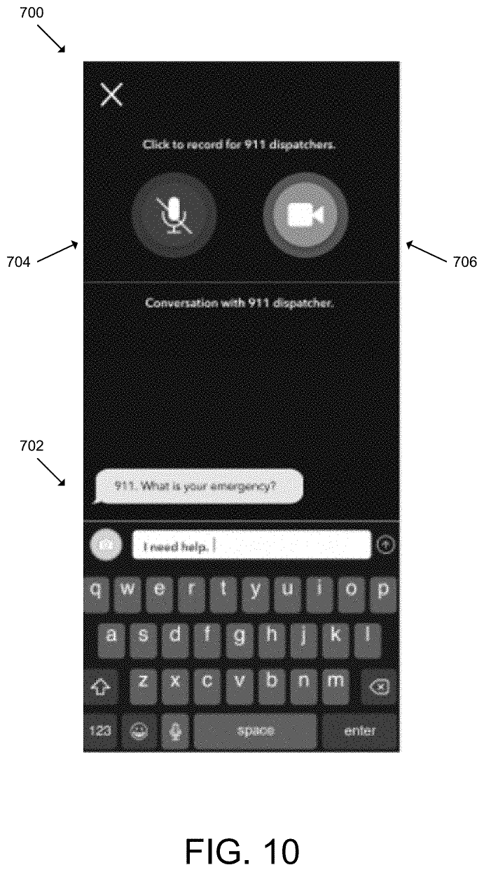

The graphical user interface 700 of FIG. 7 depicts the microphone 108 as being disabled via the audio option 704 and the camera 110 as being disabled via the video option 706. The graphical user interface 700 of FIG. 8 depicts the microphone 108 as being enabled via the audio option 704 and the camera 110 as being enabled via the video option 706. The graphical user interface 700 of FIG. 9 depicts the microphone 108 as being enabled via the audio option 704 and the camera 110 as being disabled via the video option 706. The graphical user interface 700 of FIG. 10 depicts the microphone 108 as being disabled via the audio option 704 and the camera 110 as being enabled via the video option 706. As described above, it should be appreciated that each of the microphone 110 and/or the camera 108 may be enabled or disabled by default depending on the particular embodiment. In some embodiments, the mobile device 102 permits the user to configure and/or modify such default options.

Although the blocks 302-322 are described in a relatively serial manner, it should be appreciated that various blocks of the method 300 may be performed in parallel in some embodiments. Further, it should be appreciated that, in some embodiments, two or more of the blocks 302-322 of the method 300 may be re-arranged in another order.

Returning to FIG. 5, in some embodiments, it should be appreciated that the mobile device 102 may use similar techniques to connect with a lawyer and/or third party (“In Case of Emergency” aka ICE) contact instead of or in addition to the emergency dispatch system 106. Accordingly, in some embodiments, the mobile device 102 may display a graphical user interface similar to the graphical user interface 500 of FIG. 5. As shown, the graphical user interface 500 includes a 911 option 502 (selection of which results in the features described above), a lawyer option 504, and/or an ICE option 506.

If the user selects the lawyer option 504, the mobile device 102 may automatically establish a communication connection with a computing device of a lawyer. For example, the user may use such an option during a traffic stop in order to ensure that the user's lawyer is present (virtually) during the user's exchange with the police officer (e.g., to act as a witness and/or intermediary). In some embodiments, it should be appreciated that the audio and video may both be enabled by default when the lawyer option 504 is selected; however, like with the 911 option 502, the defaults may be configured. In some embodiments, when the user selects the lawyer option 504, the mobile device 102 may also automatically transmit a message to the emergency dispatch system 106 to indicate that the user has been approached by a police officer (or alleged police officer) and a lawyer is on the line (e.g., to proactively reduce tensions and/or de-escalate).

If the user selects the ICE option 506, the mobile device 102 may automatically establish a communication connection with a predefined third party. For example, the user may predefined an emergency contact (e.g., parent, spouse, roommate, etc.). It should be appreciated that, in some embodiments, a predefined third party may also be automatically notified in response to establishing the communication connection with the emergency dispatch system 106 as described above. Further, in some embodiments, the system 100 may be configured to automatically transmit messages to third parties (whether or not defined by the user) in response to activating an option 502, 504, 506. For example, universities may rely on message data to determine the number/location at which incidences occurred.

What is claimed is:

1. A method of covert communication between a mobile device and emergency dispatch, the method comprising:
receiving, by the mobile device, a user's selection of a covert communication option on a user interface of the mobile device;
establishing, by the mobile device, a communication connection with an emergency dispatch system in response to receiving the user's selection of the covert communication option; and
launching, by the mobile device, a text-based conversation with the emergency dispatch system in response to establishing the communication connection and without revealing an existence of the communication connection to other persons in a vicinity of the mobile device.

2. The method of claim 1, further comprising providing a user interface option on the user interface to toggle enablement of a microphone of the mobile device without revealing a change in status of the microphone activity to other persons in the vicinity of the mobile device.

3. The method of claim 1, further comprising providing a user interface option on the user interface to toggle enablement of a camera of the mobile device without revealing a change in status of the camera activity to other persons in the vicinity of the mobile device.

4. The method of claim 1, further comprising:
providing a first user interface option on the user interface to toggle enablement of a microphone of the mobile device without revealing a change in status of the microphone activity to other persons in the vicinity of the mobile device; and
providing a second user interface option on the user interface to toggle enablement of a camera of the mobile device without revealing a change in status of the camera activity to other persons in the vicinity of the mobile device.

5. The method of claim 1, wherein the communication connection between the mobile device and the emergency dispatch system is unable to be disconnected by the mobile device once established.

6. The method of claim 5, further comprising closing the user interface in response to a disconnection of the communication connection between the mobile device and the emergency dispatch system by the emergency dispatch system.

7. The method of claim 1, wherein establishing the communication connection with the emergency dispatch system comprises:
initiating, by the mobile device, the communication connection with the emergency dispatch system;
providing, by the mobile device, a time delay to allow the user to cancel the communication connection for a period of time before establishing the communication connection; and
establishing the communication connection in response to the user not canceling the communication connection.

8. The method of claim 7, wherein the time delay comprises three seconds.

9. The method of claim 1, wherein establishing the communication connection comprises establishing the communication connection via an Internet Protocol (IP) connection.

10. The method of claim 1, further comprising automatically notifying, by the mobile device, a predefined third party in response to establishing the communication connection with the emergency dispatch system.

11. A mobile device for covert communication with emergency dispatch, the mobile device comprising:
a processor; and
a memory comprising a plurality of instructions stored thereon that, in response to execution by the processor, causes the mobile device to:
receive a user's selection of a covert communication option on a user interface of the mobile device;
establish a communication connection with an emergency dispatch system in response to receipt of the user's selection of the covert communication option; and
launch a text-based conversation with the emergency dispatch system in response to establishing the communication connection and without revealing an existence of the communication connection to other persons in a vicinity of the mobile device.

12. The mobile device of claim 11, wherein the plurality of instructions further causes the mobile device to provide a user interface option on the user interface to toggle enablement of a microphone of the mobile device without revealing a change in status of the microphone activity to other persons in the vicinity of the mobile device.

13. The mobile device of claim 11, wherein the plurality of instructions further causes the mobile device to provide a user interface option on the user interface to toggle enablement of a camera of the mobile device without revealing a change in status of the camera activity to other persons in the vicinity of the mobile device.

14. The mobile device of claim 11, wherein the plurality of instructions further causes the mobile device to:
provide a first user interface option on the user interface to toggle enablement of a microphone of the mobile device without revealing a change in status of the microphone activity to other persons in the vicinity of the mobile device; and
provide a second user interface option on the user interface to toggle enablement of a camera of the mobile device without revealing a change in status of the camera activity to other persons in the vicinity of the mobile device.

15. The mobile device of claim 11, wherein the communication connection between the mobile device and the emergency dispatch system is unable to be disconnected by the mobile device once established.

16. The mobile device of claim 15, wherein the plurality of instructions further causes the mobile device to close the user interface in response to a disconnection of the communication connection between the mobile device and the emergency dispatch system by the emergency dispatch system.

17. The mobile device of claim 11, wherein to establish the communication connection with the emergency dispatch system comprises to:
initiate the communication connection with the emergency dispatch system;
provide a time delay to allow the user to cancel the communication connection for a period of time before establishing the communication connection; and
establish the communication connection in response to the user not canceling the communication connection.

18. The mobile device of claim 17, wherein the time delay comprises three seconds.

19. The mobile device of claim 11, wherein to establish the communication connection comprises to establish the communication connection via an Internet Protocol (IP) connection.

20. The mobile device of claim 11, wherein the plurality of instructions further causes the mobile device to automatically notify a predefined third party in response to establishing the communication connection with the emergency dispatch system.
